(19) United States
(12) Patent Application Publication
(10) Pub. No.: US 2011/0166911 A1
(43) Pub. Date: Jul. 7, 2011

(54) Leveraging Customer Information to Create and Utilize Financial Networks

(75) Inventors: Kurt NEWMAN, Matthews, NC (US); Debashis GHOSH, Charlotte, NC (US); Timothy BENDEL, Charlotte, NC (US); David JOA, Irvine, CA (US)

(73) Assignee: BANK OF AMERICA CORPORATION, Charlotte, NC (US)

(21) Appl. No.: 12/652,628

(22) Filed: Jan. 5, 2010

(51) Int. Cl. G06Q 10/00; G06Q 40/00

(52) U.S. Cl. 705/7.33; 705/1.1; 705/319

(57) ABSTRACT

Aspects of this disclosure relate to a financial relationship and social relationship identifying computer which may include a processor and a memory storing computer executable instructions that, when executed, cause the computer to perform a method for identifying financial relationships and social relationships between customers of a business. The method for identifying financial relationship and social relationships between customers of a business may include determining one or more people with whom a first customer has conducted at least one financial transaction, electronically receiving customer data providing identities of customers of the business determining which of the one or more people are also customers of the business by comparing the one or more people with the customer data and compiling a subset of the one or more people including customers of the business with whom the first customer has conducted at least one financial transaction. The method may also include determining one or more people with whom a first customer has a social relationship.

### FIELD OF DISCLOSURE

Aspects of the present disclosure relate generally to identifying relationships between customers of a business. Particular aspects of the present disclosure relate to identifying financial relationships between customers of the business and leveraging such information to create and maintain goodwill towards the business. Particular aspects of the disclosure relate to identifying social relationships between customers of the business and leveraging such information to create and maintain goodwill towards the business.

### BACKGROUND

Goodwill towards an organization, especially a business, may be a goal for which most organizations strive. Goodwill towards a business from its customers may have a large impact on the success of the business in the future. For example, if customers are not satisfied with the business (e.g., the quality of their relationship with the business, the level of service provided by the business, etc.), then the customers may discontinue their business relationship with the business. Further, the customers may also discourage other customers they know to discontinue business relationship with the business. Additionally, even if a customer is initially satisfied with the business, but then learns from other customers with whom the customer interacts (e.g., has a business relationship with) that such customers are not satisfied with the business, then the customer may become dissatisfied with the business based on the other customer's experiences. Therefore, it would be advantageous to have a system and method that increases the likelihood that a customer will have goodwill towards a business. Further, it would be advantageous to have a system and method that increases the likelihood that the other customers with whom a customer interacts will also have goodwill towards a business.

### SUMMARY

In light of the above, it would be beneficial to provide a system and a method that increases the likelihood that customers will have goodwill towards a business by identifying financial relationships between customers of a business and providing an appropriate level of service to all customers of the business associated with the identified financial relationships.

Therefore, aspects of this disclosure relate to a financial relationship and social relationship identifying computer which may include a processor and a memory storing computer executable instructions that, when executed, cause the computer to perform a method for identifying financial relationships and social relationships between customers of a business. The method for identifying financial relationship and social relationships between customers of a business may include determining one or more people with whom a first customer has conducted at least one financial transaction, electronically receiving customer data providing identities of customers of the business determining which of the one or more people are also customers of the business by comparing the one or more people with the customer data and compiling a subset of the one or more people including customers of the business with whom the first customer has conducted at least one financial transaction. The method may also include determining one or more people with whom a first customer has a social relationship by electronically receiving customer financial transaction history data, determining customer transactions which occur at a common location within a predetermined amount of time relative to a second transaction, determining in which groups of customers such transactions occurred more than a predetermined amount of times over a predetermined time period and inferring social relationship between the customers of the business when the transactions occurred more than a predetermined amount of times over a predetermined time period.

Additional aspects of this disclosure relate to a computer assisted method for identifying financial relationships between customers of a business. The computer assisted method may include electronically receiving data which contains a list of people with whom a first customer of the business has conducted at least one financial transaction, electronically receiving data regarding the identities of customers of the business and using a financial relationship identifying computer to determine which of the people with whom a first customer has conducted at least one financial transaction are also customers of the business by comparing the data relating to people with whom a first customer has conducted at least one financial transaction with the data regarding the identities of customers of the business. The computer assisted method may further include using a financial relationship identifying computer to compile a list of customers of the business with whom a first customer has conducted at least one financial transaction.

Aspects of this disclosure relate to a computer assisted method for providing a level of service to customers of a business. The computer assisted method may include electronically receiving data which contains a list of people with whom a first customer of the business has conducted at least one financial transaction, electronically receiving data regarding the identities of customers of the business, and using a financial relationship identifying computer to determine which of the people with whom a first customer has conducted at least one financial transaction are also customers of the business by comparing the data relating to people with whom a first customer has conducted at least one financial transaction with the data regarding the identities of customers of the business. The computer assisted method may also include using a financial relationship identifying computer to compile a list of customers of the business with whom a first customer has conducted at least one financial transaction, electronically receiving data regarding the level of service to be provided to a first customer and providing the customers of the business with whom a first customer has conducted at least one financial transaction with at least the same level of service that is to be provided to a first customer.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 illustrates a block diagram of a computing environment in which certain aspects of the present disclosure may be implemented;

FIG. 3 illustrates a flow chart which describes an illustrative process for updating the list of other persons with whom the customer has interacted with financially using payee information from a check according to aspects of the disclosure;

FIG. 4 an illustrative method for updating the list of other persons with whom the customer has interacted with financially using payee information from an online transaction according to aspects of the disclosure;

FIG. 5 illustrates a diagram representing an example of a financial network according to aspects of this disclosure;

FIG. 6 an illustrative method for creating a financial network according to aspects of the disclosure;

FIG. 7 an illustrative method for creating a financial network according to aspects of the disclosure;

FIG. 8 illustrates a block diagram of a computing environment in which certain aspects of the present disclosure may be implemented;

FIG. 9 illustrates a flow chart which describes an illustrative process for determining a list of persons with whom a social connection with a customer may be inferred according to aspects of the disclosure; and

FIG. 10 illustrates a diagram representing an example of a financial network according to aspects of this disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term business may be used interchangeably with organization, financial institution, bank, etc. The term business is not intended to be limiting, but rather merely describe a potential embodiment of the disclosure.

As described above, one goal of a business is to create and maintain goodwill towards the business amongst its customers. For example, if a customer is generally satisfied with the business (e.g., the quality of their relationship with the business, the service level provided by the business, etc.), the customer is likely to continue the relationship. The continuation of the relationship may provide future business and income for the business. Further, if a customer is generally satisfied with the business, the customer is likely to refer others (e.g., colleagues, friends, relatives) to the business. Such referrals may provide additional future business and income for the business.

In contrast to the above described scenarios, if a customer is dissatisfied with the business, the customer is likely to discontinue the relationship. Further, the customer is likely to discourage others (e.g., colleagues, friends, relatives) from creating or continuing business relationships with the business. Therefore, it is likely the business will lose potential future business and income if the customer is dissatisfied. Therefore, it is understood that creating and maintaining goodwill towards the business may be instrumental in creating future business and income for the business and, overall, contributes to the well being of the business.

One way a business may attempt to maintain goodwill with existing customers is to ensure the customers are satisfied with their particular relationship with the business, by providing a high level of service to the customer. This may be particularly useful for high value customers (e.g., customers who conduct a large amount of transactions with the business, provide a large amount of income for the business, etc.). For example, the business may offer preferred treatment to such high value customers.

However, as can be understood from the above examples, interactions between different customers who know each other (e.g., discussions about the personal experiences with the business) may also affect the goodwill towards the business. Therefore, merely providing preferred treatment to such high value customers may not necessarily ensure the goodwill of high value customers. For example, if a first customer is provided with a high level of service whenever they are interacting with the business, then the customer is likely to be satisfied with the business. Yet, the first customer may have a colleague, friend, relative, etc. who is also a customer of the business. The two customers may discuss their personal experiences with the business. If the first customer's colleague has had a negative experience with the business, that may cause the first customer to grow dissatisfied with the business. In other words, if a customer discovers that their colleague, friend, relative, etc. is not being treated with the same high level of service by the business, then the first customer may grow dissatisfied with the business, despite the high level of service the first customer receives. Hence, while it is advantageous to attempt to ensure that a particular customer is satisfied with the business by providing them with a high level of service, it is also advantageous to attempt to ensure that other customers with whom the customer interacts (e.g., the customer's colleagues, friends, relatives, etc.) are also treated with a high level of service as well. Further, as discussed above, if a customer is a high value customer, then it is particularly advantageous to attempt to maintain goodwill with that existing customer and, also, attempt to maintain goodwill with the people with whom that customer interacts.

Therefore, aspects of this disclosure relate to a system and method of identifying other customers of the business with whom a first customer interacts and providing those other customers the same level of service as the first customer. Aspects of this disclosure relate to a system and method of identifying other customers of the business with whom a customer conducts financial transactions and providing those other customers with at least the same level of service as the customer. Further, aspects of this disclosure relate to a system and method of identifying other customers of the business with whom a customer interacts socially and providing those other customers with at least the same level of service as the customer.

Hence, aspects of this disclosure relate to a system and method which ascertains and identifies other persons (e.g., other customers of the business) with whom a customer conducts financial transactions. By identifying such other persons with whom a customer conducts financial transactions, the business may attempt to ensure that the other persons are provided at least a same level of service as the customer and, thereby, attempt to maintain goodwill toward the business among such customers.

Further, aspects of this disclosure relate to a system and method which ascertains and identifies other persons (e.g., other customers of the business) with whom a customer interacts socially. By identifying such other customers of the business with whom a customer interacts socially, the business may attempt to ensure that the other persons are provided at least a same level of service as the customer and, thereby, attempt to maintain goodwill toward the business among such customers. It is noted that according to aspects of the disclosure, the process of identifying other customers of the business with whom a customer interacts socially may involve leveraging inferred connections between customer of the business based on factors such as the date and time of the transactions, the location of the transactions, frequency of transactions, etc.

According to aspects of this disclosure, the business attempting to ascertain and identify other persons (e.g., other customers of the business) with whom a customer conducts financial transactions or interacts with socially may be a bank. In such a situation, the bank can leverage information the bank already has about the customer in order to ascertain and identify other persons (e.g., other customers of the bank) with whom a customer conducts financial transactions or interacts with socially. For example, the according to aspects of this disclosure, the bank may use information from: a stored customer profile, a check the customer has written to another person (i.e., a payee) or received from another person (i.e., a payer), an online transaction, another form of transaction (e.g., a wire transfer), transaction history, including dates and times of the transactions, the location of the transactions, frequency of transactions, etc. in order to identify other persons with whom a customer conducts financial transactions or interacts with socially.

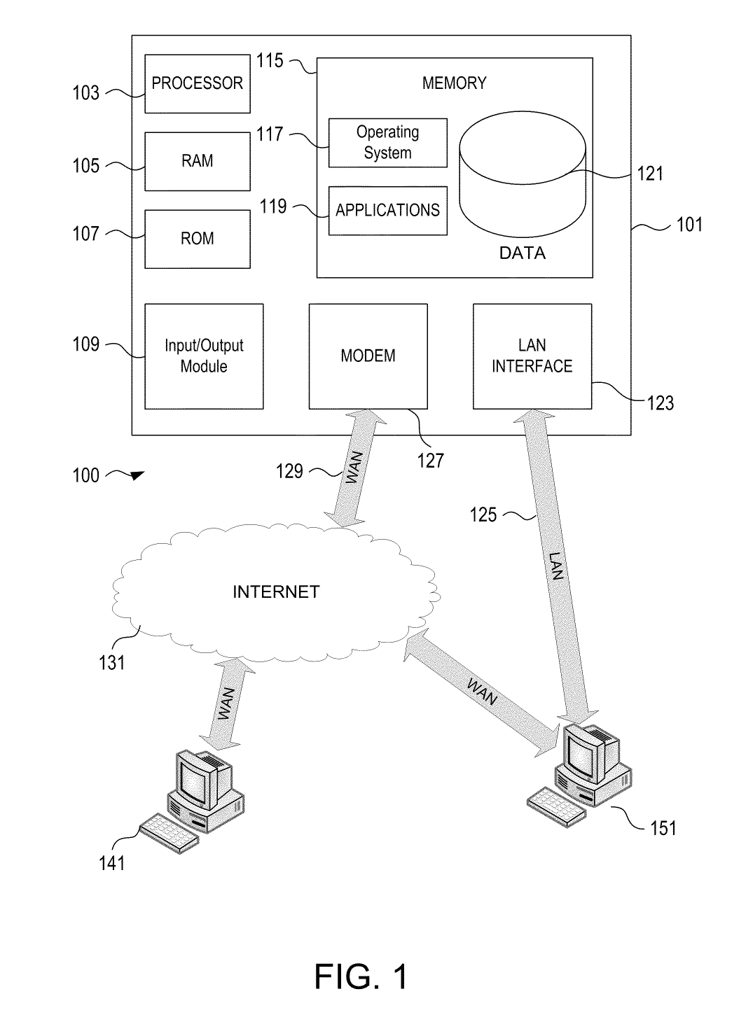

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

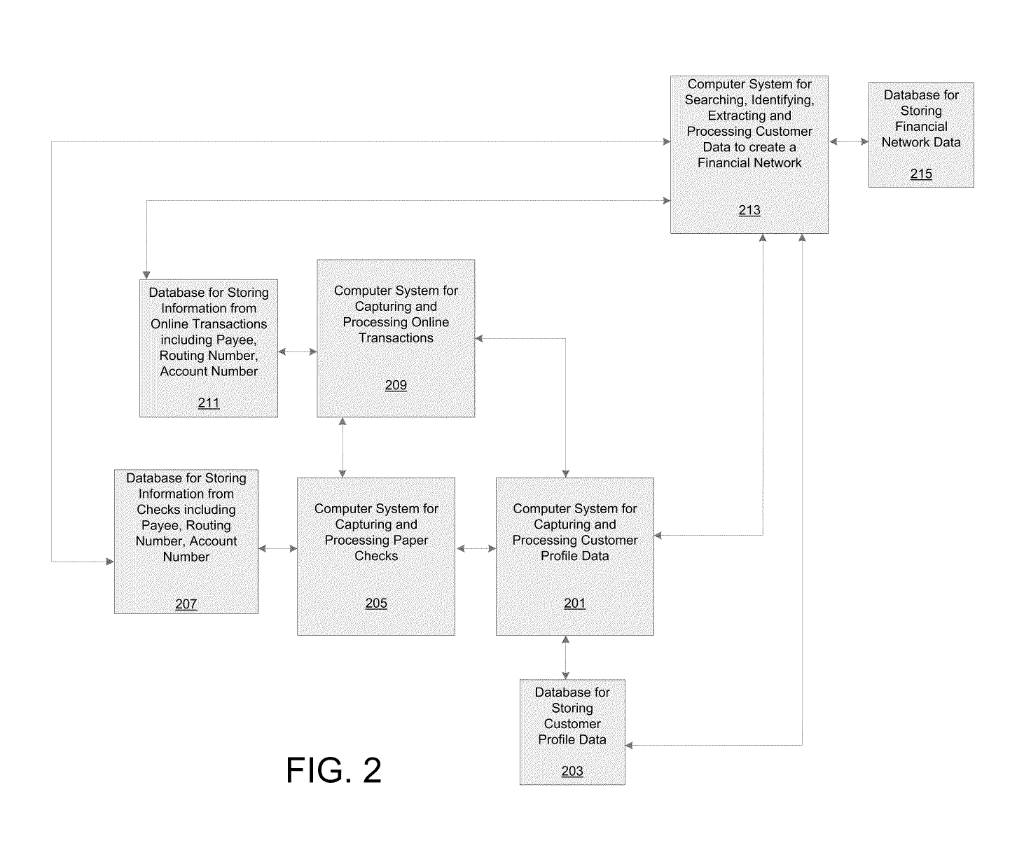

According to aspects of this disclosure, a bank may have one or more computer systems that captures and stores such information about a customer and, therefore, the bank may leverage the information in order to ascertain and identify other persons (e.g., other customers of the business) with whom a customer conducts financial transactions. FIG. 2 illustrates a block diagram of a computing environment in which certain aspects of the present disclosure may be implemented. As seen in FIG. 2, a bank may have one or more computer systems 201 that are used for capturing and processing data related to customer profiles. Additionally, as seen in FIG. 2, a bank may have one or more computer systems 205 that are used for capturing and processing data used for payments made by check. Further, as seen in FIG. 2, a bank may have one or more computer systems 209 that are used for capturing and processing data used for online transactions. The bank may also have one or more computer systems for capturing and processing data used in other methods of financial transactions.

According to aspects of the disclosure, a bank may create a customer profile for customers of the business. For example, according to aspects of this disclosure, a bank may have one or more computer systems 201 that are used for capturing and processing data related to the above described current customers' profiles. For example, a bank may have one or more computer systems 201 that are used for capturing and processing data about customers and their financial relationships with the bank, such as: customer name, address, telephone number, email address, age, credit score, income, debt, place of employment (and its contact information, such as address, telephone numbers, etc.), the type of financial relationship/account (e.g., a loan, insurance, savings account, checking account, etc.), term of the relationship (e.g., term of a loan, the time current customer has been with the bank, etc.), etc. The computer systems 201 used for capturing and processing customer profile data, may be configured to allow customers to input such customer profile data (e.g., via a web based system) or allow bank employees to enter such customer profile data. Further, the computer systems 201 may include one or more databases 203 for storing the customer profile data. For example, if the customer or bank employee enters such customer profile data, then the customer profile data may be stored in a database 203 associated with the computer systems 201 used for capturing and processing customer profile data. Also, the computer systems 201 used for capturing and processing current customer profile may be configured to transmit or receive the customer profile data (e.g., to/from other computer systems or databases within the bank).

According to aspects of the disclosure, the customer profile may also include information on other persons (e.g., other customers of the business) with whom the customer interacts (e.g., financially). In other words, the customer profile may also include a list of other customers of the bank with whom the customer has interacted with financially (i.e., with whom the customer has conducted financial transactions). This information may have been provided by the customer or the bank may ascertain and indentify other persons with whom the customer has interacted with financially, by examining the customer's financials transactions.

For example, according to one embodiment of the disclosure, a bank may use a check to identify other persons that the customer interacts with financially. According to aspects of the disclosure, the bank may indentify checks that are drawn from a customer's account. The bank may identify the payee to which the checks are paid. The bank may capture such payee information and store such information in the customer profile database. In other words, the payee on the check may be added to the list of other persons with whom the customer has interacted with financially. Capturing such information from a check may be done manually or the bank may use on or more computer systems.

For example, according to aspects of the disclosure, one or more computer systems 205 may be used for capturing and processing data from checks. For example, such computer systems 205 may be configured to retrieve from the checks, the routing numbers, account numbers, payee information, payer information, etc. For example, the computer systems 205 may include one or more scanning devices which scan paper checks and create electronic images of the paper checks that the computer systems 205 will store in one or more databases. Further, the computer systems 205 may be configured to extract and read the routing numbers, account numbers, payee information, payer information, etc. from the paper check or the electronic image of the paper check (e.g., Optical Character Recognition (OCR) software or the like). Additionally, the computer systems 205 used for capturing and processing data from checks may include one or more databases 207 for storing the routing numbers, account numbers, payee information, payer information, etc. For example, once a paper check has been scanned and routing numbers, account numbers, payee information, payer information, etc. from the check has been extracted and read, the routing numbers, account numbers, payee information, payer information, etc. may be stored in a database 207 associated with the computer systems 205 used for capturing and processing data from checks. Also, the computer systems 205 used for capturing and processing data for checks may be configured to transmit the routing numbers, account numbers, payee information, payer information, etc. (e.g., to other computer systems or databases within the bank, such as the customer profile computer system and database 201, 203).

According to aspects of this disclosure, the bank may scan the checks when they are returned to the bank for payment by the payee's bank. For example, the checks may be scanned and the routing number and account number information can be used to identify the particular customer of the bank who wrote the check. Further, once that information is ascertained, the payee information can be extracted and stored in the customer profile of the customer associated with the account from which the check was drawn. In other words, the payee on the check may be added to the list of other persons with whom the customer has interacted with financially. It is noted that, of course, instead of paper checks, electronic images of checks can be processed in a similar manner.

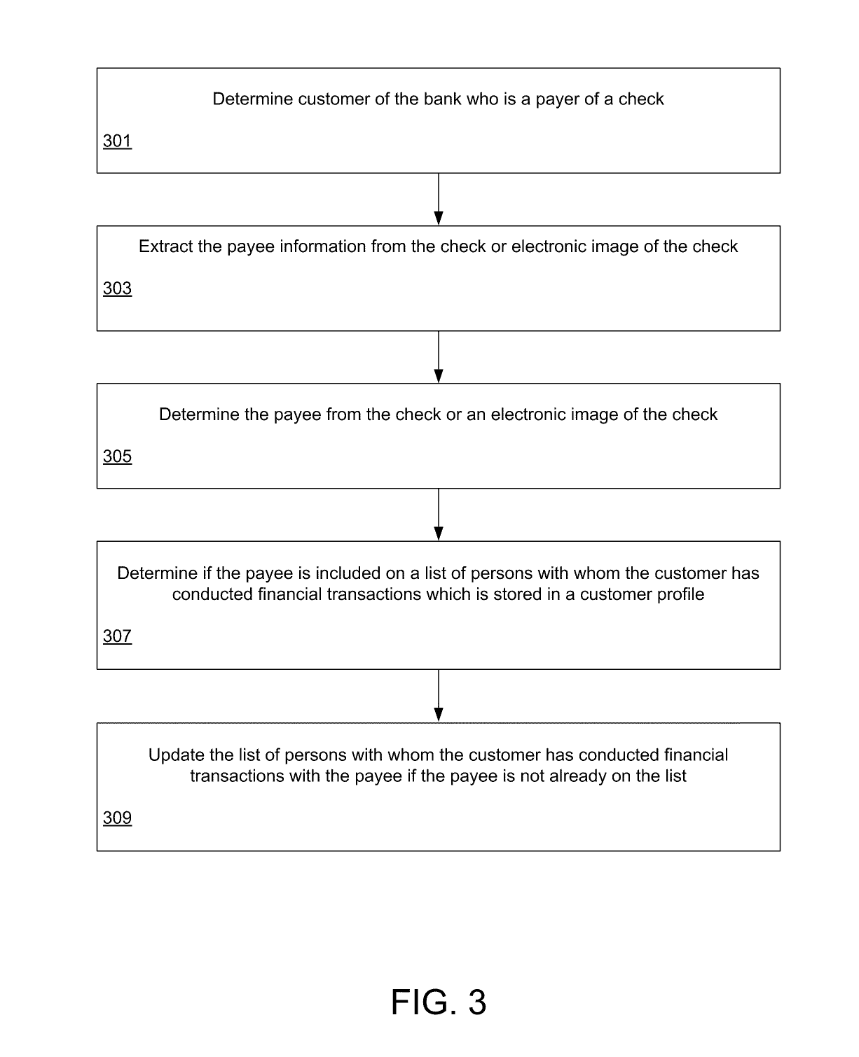

FIG. 3 is a flow chart showing an illustrative method for updating the list of other persons with whom the customer has interacted with financially using payee information from a check according to aspects of the disclosure. As seen in FIG. 3, in step 301 the bank may determine the particular customer of the bank who is the payer of the check (i.e., the customer associated with the account from which the check is drawn). In step 303, the bank may extract payee information from the check or an electronic image of the check. In step 305, the bank may determine the payee from the check or an electronic image of the check. In step 307, the bank may determine if the payee is included in the list of persons with whom a customer has conducted financial transactions. This list may be stored in the customer's profile. In step 309, the bank may update the list of persons with whom a customer has conducted financial transactions with the payee if the person is not already on the list. It is noted that this process may be conducted done via a computer system as described in detail above.

According to aspects of this disclosure, the bank may scan checks that have been written to the customer from other persons when they are presented to the bank by the customer (e.g., during a deposit). In order to extract the payer information, the bank may process the check in a manner similar to that described above. The computer system may then update the customer profile of the customer presented the check to the bank (e.g., the customer depositing the check) with the name of the payer who wrote the check. In other words, the payer on the check may be added to the list of other persons with whom the customer has interacted with financially. It is noted that this process may be conducted done via a computer system as described in detail above.

Further, the bank may use other financial transactions, such as online transactions, to ascertain and identify other persons (e.g., other customers of the business) with whom a customer interacts. According to aspects of the disclosure, the bank may indentify online transactions wherein funds are drawn from a customer's account. The bank may identify the payee to which the online transactions are paid. The bank may capture such payee information and store such information in the customer profile database. In other words, the payee in the online transaction may be added to the list of other persons with whom the customer has interacted with financially.

According to aspects of the disclosure, one or more computer systems 209 may be used for capturing and processing data for online transactions. Such computer systems 209 may be configured to allow customers to input routing numbers, account numbers, payee information, payer information, etc. Further, the computer systems 209 may be configured to transmit and receive funds using the routing numbers, account numbers, payee information, payer information, etc. inputted by the customers. Additionally, the computer systems 209 used for capturing and processing data for online transactions may include one or more databases 211 for storing the routing numbers, account numbers, payee information, payer information, etc. For example, if the customer conducts a single online transaction or schedules recurring automatic online transactions, routing numbers, account numbers, payee information, payer information, etc. may be captured and stored in a database 211 associated with the one or more computer systems 209 used for capturing and processing data for online transaction. Also, the computer systems 209 used for capturing and processing data for online transactions may be configured to transmit the routing numbers, account numbers, payee information, payer information, etc. (e.g., to other computer systems or databases within the bank, such as the customer profile computer system and database 201, 203).

According to aspects of this disclosure, when the customer of the bank makes an online payment, the computer system 209 may extract the payee name (alternatively the computer system may extract a routing number and an account number) to identify the payee of the online transaction. Further, once that information is ascertained, the payee information (e.g., a payee name) may be stored in the customer profile of the customer associated with the online account from which the payment was made. In other words, the payee of the online payment from the customer of the bank may be added to the list of other persons with whom the customer has interacted with financially.

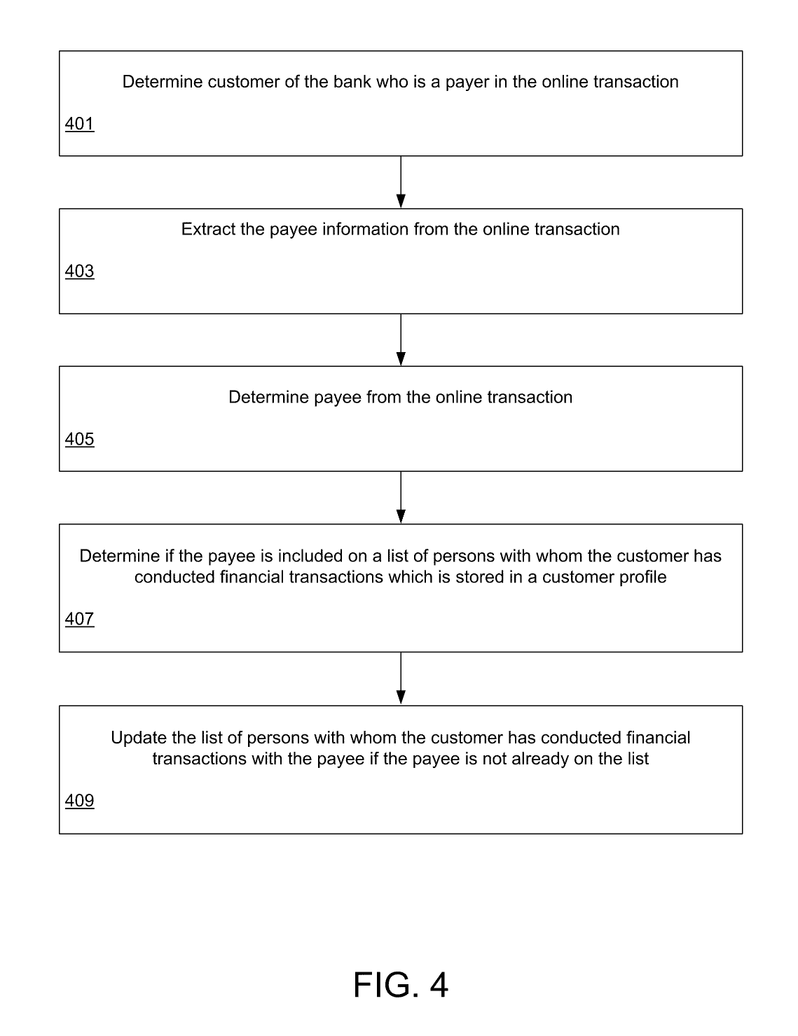

FIG. 4 is a flow chart which illustrates an illustrative method for updating the list of other persons with whom the customer has interacted with financially using payee information from an online transaction according to aspects of the disclosure. As seen in FIG. 4, in step 401 the bank may determine the particular customer of the bank who is the payer in the online transaction (i.e., the customer associated with the account from which the online transaction is made). In step 403, the bank may extract payee information from the online transaction. In step 405, the bank may determine the payee from the online transaction. In step 407, the bank may determine if the payee is included in the list of persons with whom a customer has conducted financial transactions. This list may be stored in the customer's profile. In step 409, the bank may update the list of persons with whom a customer has conducted financial transactions with the payee if the person is not already on the list. It is noted that this process may be conducted done via a computer system as described in detail above.

According to aspects of this disclosure, bank may process online payments received by the customer in a similar manner. For example, the computer system 209 may extract the name of the payer who paid the customer of bank using the online transaction (alternatively, the computer system may extract the routing number and account number to indentify the payer). The computer system may then update the customer profile of the customer who received the payment with the name of the payer who paid the customer via the online payment. In other words, the payer who paid the customer via the online payment may be added to the list of other persons with whom the customer has interacted with financially. It is noted that this process may be conducted done via a computer system as described in detail above.

It is noted that other transactions (e.g., wire transfers, etc.) may be used in a similar manner, to ascertain and identify other persons (e.g., other customers of the business) with whom a customer interacted (e.g., conducted financial transactions).

According to aspects of the disclosure, the bank may utilize information in the customer profiles (e.g., the above described listings of other persons with whom a customer has conducted financial transactions) in order to create a financial network. For example, according to aspects of this disclosure, the bank may create a financial network which identifies the customers of the bank and also identifies, for each particular customer of the bank, the other customers with which that particular customer has had some financial interaction.

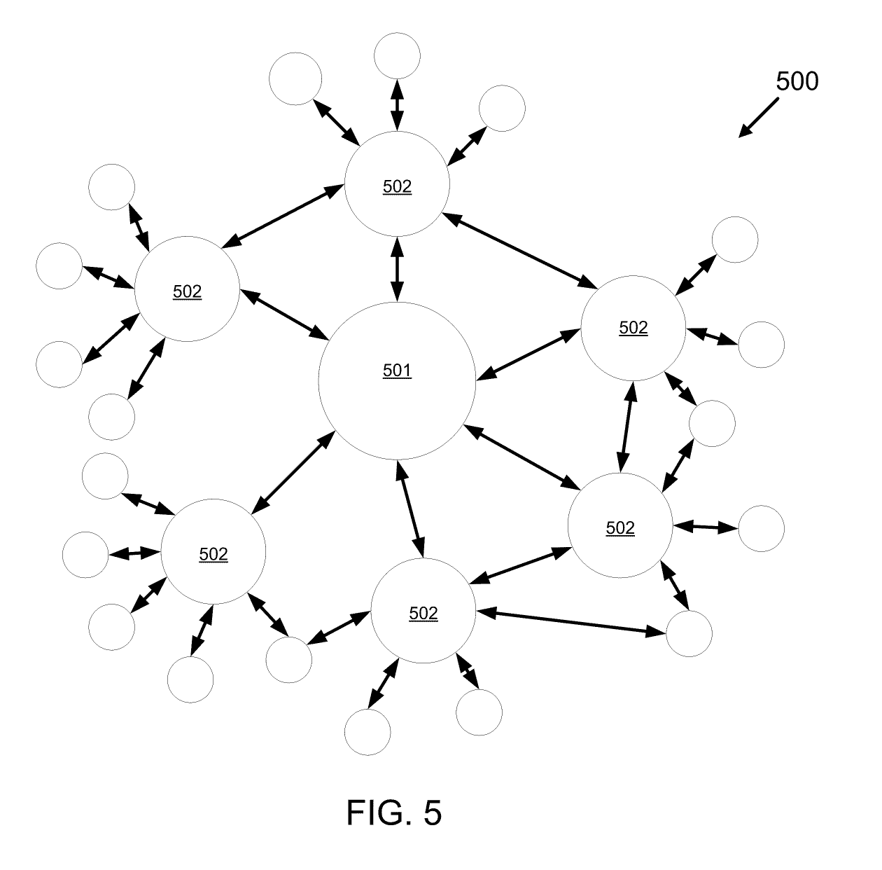

FIG. 5 is an illustrative a diagram representing an example of a financial network 500 according to aspects of this disclosure. As seen in FIG. 5, a first customer 501 has conducted financial transactions with six other customers 502 of the bank. For reference purposes, the six other customers with whom the first customer transacted will be referred two as second customers, 502. This information of which customers with whom the first customer has conducted financial transactions may be obtained from the listing of customers with whom the first customer has conducted financial transactions that is stored in the first customer's customer profile as described above. Further, as seen in FIG. 5, each of the second customers 502 has conducted their own financial transactions with six customers of the bank (including the first customer 501 and, in some cases, some of the same second customers 502 with which the first customer 501 interacted). Again, this information of which customers with whom the second customers have conducted financial transactions may be obtained from the various listings of customers with whom each of the second customers have conducted financial transactions that are stored in the respective second customers' customer profile as described above. As will be described below, the bank may use one or more computers to extract the above information and also process the information to identify the financial connections between customers of the bank.

The group of customers shown in FIG. 5 is considered an example of a financial network 500 of customers of the bank, due to the one or more financial transactions linking the customers with each other. Further, it is noted that the example of the financial network 500 shown in FIG. 5 may be relatively small and according to aspects of the disclosure, the bank may create a financial network 500 that accounts for all the customers of the bank. According to aspects of the disclosure, the financial network 500 may contain all the bank's customers, and identify all the financial connections between the customers of the bank (i.e., identify whether a financial transaction has been conducted between two customers).

Additionally, the financial networks 500 may identify other financial relationships or financial connections between customers of the bank. For example, different customers who indirectly conduct financial transactions with each other or different degrees of separation between customers, etc. As will be described in detail below, the financial network 500 and the financial connections which it identifies may be leveraged by the bank for several purposes.

According to one or more aspects of the disclosure, a bank may have one or more computer system 213 that are configured to create and maintain financial networks 500. According to aspects of the disclosure, computer systems 213 may search for, indentify, extract, or otherwise receive, and process data from the above described customer profile database 203. For example, the computer system 213 may search the customer profiles stored in the customer profile database 201 for the above described listings of other persons with whom the customer has financially interacted (e.g., conducted a financial transaction, such as a making or receiving a payment). Further, according to aspects of the disclosure, computer systems 213 may be configured to retrieve (or otherwise electronically receive) information from the customer profiles such listings of other persons with whom the customer has financially interacted.

According to aspects of the disclosure, in order to identify which of the other persons in the listing are actually customers of the bank, computer system 213 may be configured to process data from the listing of other persons with whom the customer has financially interacted. In other words, the above described methods of determining persons with whom the customer has conducted a financial transaction may obtain information about various people with whom the customer has conducted a financial transaction, including people who are not customers of the bank. For example, a customer of the bank may write a check to or receive a check from a person who is not a customer of the bank. Similarly, online transactions, wire transfers, etc. may be conducted between the customer of the bank and non customers of the bank. Hence, non-customers of the bank (and data related to them) may be stored in the customer profile database. According to aspects of this disclosure, computer system 213 may be configured to determine which persons in the list of people with whom the customer has conducted a financial transaction (that stored in the customer database) are actually also customers of the bank. According to aspects of the disclosure, in order to make such a determination, the computer system 213 may compare the list in the customer profile with a master list of all the customers of the bank so as to ascertain which names on the list are also customers of the bank. As will be described below, once this determination has been made, the computer system 213 may leverage this data in order to create the financial network 500.

For example, using the data described above, the computer system 213 may create a financial network for each individual customer. In other words, according to aspects of the disclosure, the financial network 500 may be compilation of data that identifies the financial interaction or potential financial interaction between different customers of the bank. As seen in FIG. 5, such a financial network may be presented in graphical from, but may be represented in other formats also, such as a spreadsheet. According to aspects of the disclosure, computer system 213 may be configured to store such financial network information in the financial network database 215.

According to some aspects of the disclosure, in addition to identifying any customers of the bank who have directly conducted a financial transaction with each other, according to aspects of the disclosure, the computer system 213 may be configured to identify a second degree of customers for each customer. This second degree of customers would be any customers who have not conducted any direct financial transactions with a first customer, but instead have conducted direct financial transactions with other customers who have in turn conducted direct financial transactions with the first customer. The computer system 213 may use the initial financial network 500 data, to determining a second degree of customer by determining the second customers with which a first customer has directly conducted a financial transaction and then determining the each of the customer of the second customer has conducted a financial transaction with. The computer system 213 may be configured to store such financial network information in the financial network database 215. Such data may be particularly helpful and it shows the potential interaction that a first customer might have with a second degree customer. Hence, if desired the same level of service may be extended to the second degree customer. It is noted that the computer system 213 may be configured to identify multiple degrees of customer financial interaction as desired.

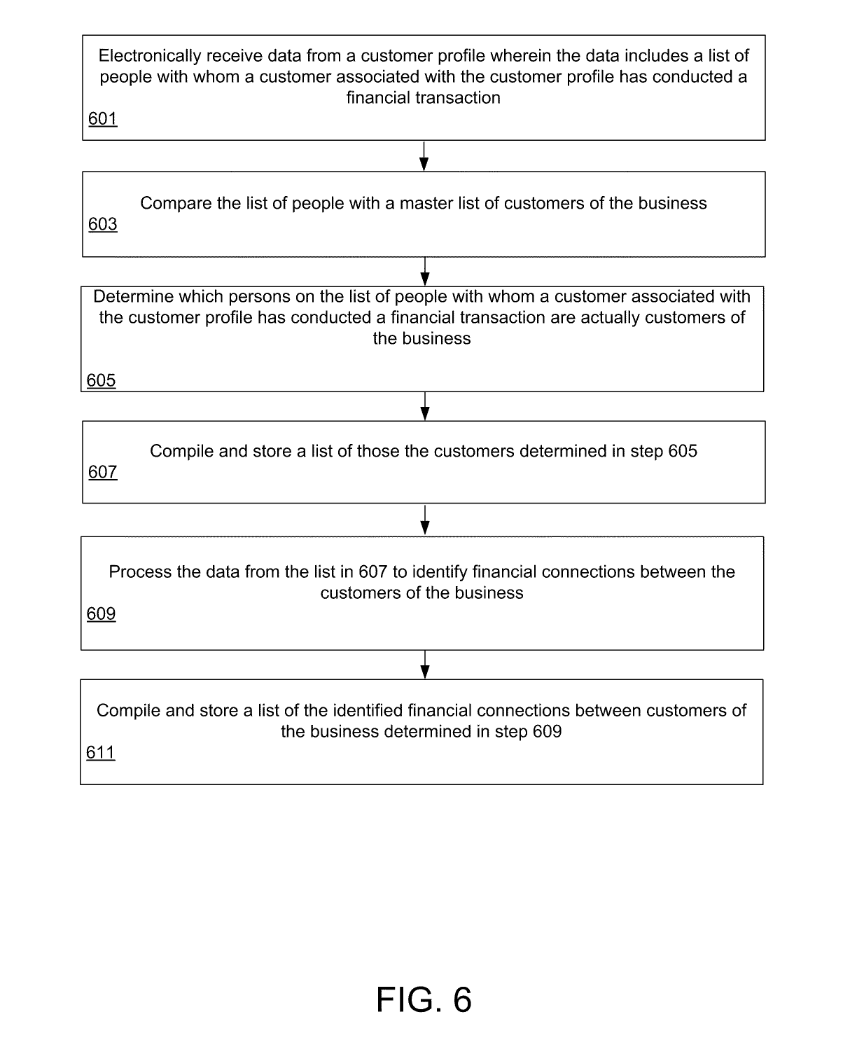

FIG. 6 is a flow chart which illustrates an illustrative method for creating a financial network according to aspects of the disclosure. As seen in FIG. 6, in step 601 the bank may use a computer system 213 to search the customer profile database for data relating to the people with whom the customer associated with the particular customer profile has conducted a financial transaction. For example, the computer system 213 may electronically receive data from a customer profile wherein the data includes a list of people with whom a customer associated with the customer profile has conducted a financial transaction. In step 603, the computer system 213 may compare the list of people with whom a customer associated with the customer profile has conducted a financial transaction with a master list of all the customers of the business. In step 605, based on the comparison, the computer system 213 may determine which persons on the list of people with whom a customer associated with the customer profile has conducted a financial transaction are actually customers of the business. In step 607, the computer system 213 may compile and store a list of those the customers determined in step 605. In step 609, the computer system 213 may process the data from each of the lists created in step 607 to identify financial connections between the customers of the business. It is noted that these financial connections may include the above described multiple degrees of customer financial interaction, such as: customer who directly conduct financial transactions with each other, a second degree of customers who have not conducted any direct financial transactions with a first customer, but instead have conducted direct financial transactions with other customers who have in turn conducted direct financial transactions with the first customer, etc. In step 611, the computer system 213 may compile and store a list of the identified financial connections between customers of the business determined in step 609.

Further, according to aspects of the disclosure, the computer system 213 may combine the information in the above described lists of each of the respective customers and then correlate such information. According to such aspects of this disclosure, the computer systems 213 may be configured to process such information on the financial connections between customers in order to create a financial network 500 of all the customers of the bank. In other words, the computers systems 213 may create a financial network of the customers of the bank based on the indentified financial connections between customers described above. According to aspects of this disclosure, the computer systems 213 may be configured to store such information on the financial connections between customers and the financial network 500 in the financial network database 215.

For example, once the lists have been combined, the computer system may remove redundancies (e.g., if a first customer has conducted a transaction with a second customer, then the direct financial connection between the two customers is indentified and established and, therefore, that same information which would come from the second customer's listing of customer with whom the second customer has conducted financial transactions may be disregarded). The computer system may process the list for each respective customer and supplement the financial network 500 with the information from each list. Hence, upon complete the processing for each list, the computer system 213 will have created an initial financial network 500 for all the customers of the bank.

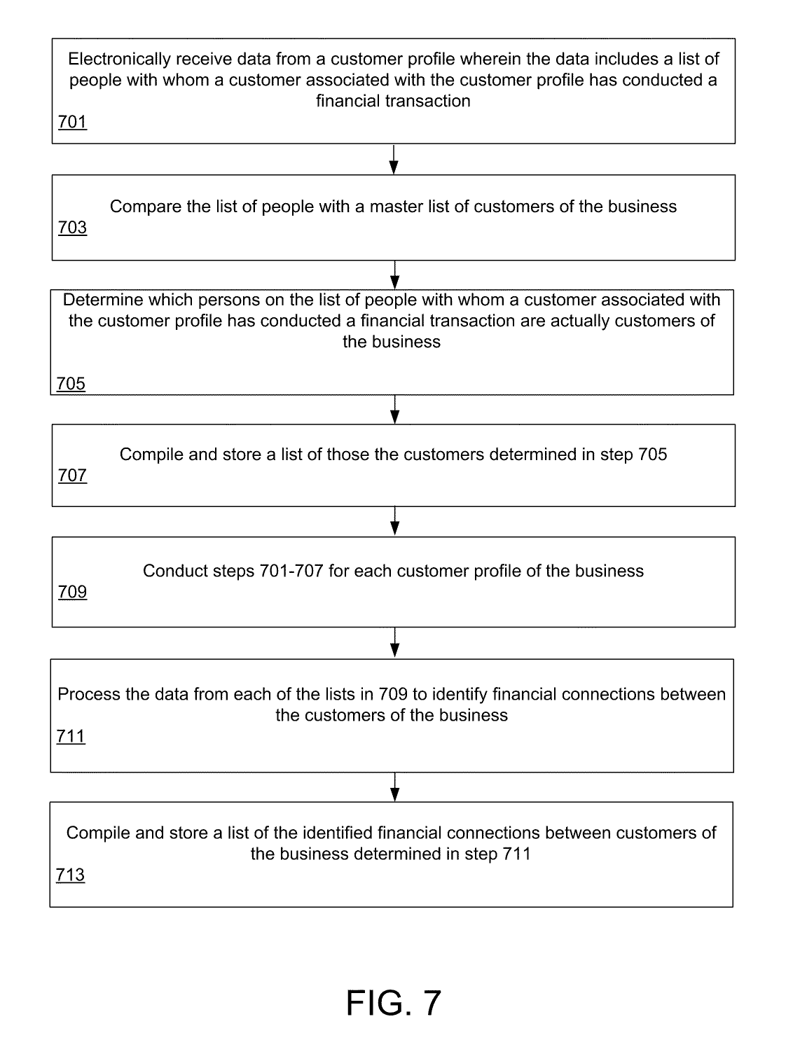

FIG. 7 is a flow chart which illustrates an illustrative method for creating a financial network according to aspects of the disclosure. As seen in FIG. 7, in step 701 the bank may use a computer system 213 to search the customer profile database for data relating to the people with whom the customer associated with the particular customer profile has conducted a financial transaction. For example, the computer system 213 may electronically receive data from a customer profile wherein the data includes a list of people with whom a customer associated with the customer profile has conducted a financial transaction. In step 703, the computer system 213 may compare the list of people with whom a customer associated with the customer profile has conducted a financial transaction with a master list of all the customers of the business. In step 705, based on the comparison, the computer system 213 may determine which persons on the list of people with whom a customer associated with the customer profile has conducted a financial transaction are actually customers of the business. In step 707, the computer system 213 may compile and store a list of those the customers determined in step 705. In step 709, the computer system may repeat the above described process for each of the customer profiles of the business. Once that has been done for each of the customer profiles of the business, in step 711, the computer system 213 may process the data from each of the lists created in step 709 to identify financial connections between the customers of the business. It is noted that these financial connections may include the above described multiple degrees of customer financial interaction, such as: customer who directly conduct financial transactions with each other, a second degree of customers who have not conducted any direct financial transactions with a first customer, but instead have conducted direct financial transactions with other customers who have in turn conducted direct financial transactions with the first customer, etc. In step 713, the computer system 213 may compile and store a list of the identified financial connections between customers of the business determined in step 711.

According to aspects of the disclosure, a financial network 500 may include additional information regarding the financial relationship between two customers. In other words, while according to some aspects of the disclosure, the framework of the financial network may be based on whether a financial relationship exists between two customers (e.g., whether a financial transaction was conducted between two customers), the financial network 500 can include further detailed information regarding the financial relationship between the two customers.

For example, according to aspects of the disclosure, the computer system 213 may be configured to electronically receive information regarding the frequency of the transactions between two customers. In other words, the computer system 213 may determine if transactions between the two customers are conducted frequently or rarely (e.g., if there has only been a single transaction between two customers). The computer system 213 may determine whether there has been more than a predetermined number of transactions (e.g., 10) between the customers. According to aspects of the disclosure, there may be different rankings or levels within the financial network based on the number of transactions. For example, if a first customer conducts frequent transactions with a second customer, then the second customer may be considered priority financial contact of the first customer. Alternatively, if a first customer has only conducted one or two transactions with a second customer, then the second customer may not be considered priority financial contact of the first customer.

According to aspects of the disclosure, the computer system 213 may be configured to electronically receive information regarding the time period since the most recent transaction between two customers. In other words, the computer system 213 may determine if the most recent transaction between the two customers was within a predetermined amount of time (e.g., 2 years). According to aspects of the disclosure, there may be different rankings or levels within the financial network based on the time period since the most recent transaction between the two customers. For example, if a first customer has not conducted a transaction with a second customer within the past two years, then the second customer may not be considered priority financial contact of the first customer. Alternatively, if a first customer has conducted at least one transaction with the second customer, then the second customer may be considered priority financial contact of the first customer.

According to aspects of the disclosure, the computer system 213 may be configured to electronically receive information regarding the amount of funds involved in the transactions between two customers. In other words, the computer system 213 may determine if transactions between the two customers are more or less than a predetermined number (e.g., $10,000). This predetermined number could be determined on a per transaction basis or a cumulative basis. According to aspects of the disclosure, there may be different rankings or levels within the financial network based on the amount of funds involved in the disclosure. For example, if a first customer conducts transactions with a second customer that involve more than a predetermined amount of funds, then the second customer may be considered priority financial contact of the first customer. Alternatively, if a first customer conducts transactions with a second customer that involve less than a predetermined amount of funds, then the second customer may not be considered priority financial contact of the first customer.

Of course, the above described examples of additional information that can be used to supplement the financial network framework are not an exhaustive list and other criteria may be used as well. For example, the length of time that two customers have known each other (as evidenced by the date of their first transaction) may be another example of information with which the financial network may be supplemented. Additionally, it is noted that according to aspects of the disclosure, the framework itself of the financial network may be based on such criteria. For example, according to one aspect of the disclosure, two customers must have at least a predetermined amount of funds involved in the transactions (e.g., $10,000) in order to even be listed in the financial network. Various other filters could be used as desired.

It is noted that such information regarding frequency of the transactions, dates of the transactions, amount of the transactions, can be retrieved from the databases 207, 209 in addition to database 203.

According to aspects of this disclosure, the computer system 213 may be configured to transmit data regarding the financial network 500 and the financial connections between customers within the financial network to the customer profiles contained in the customer profile database 203. In other words, customer profiles contained in the customer profile database 203 may be updated based on the information ascertained from the financial network 500. For example, according to aspects of the disclosure, the lists of other persons with whom a first customer has conducted a financial transaction, that are stored in the customer profiles may be updated with data determined for or from the financial network 500, so that the lists in the customer profiles now indicate which of the persons in the list are actually customers of the bank. Based on this update, the names on the list in the customer profile may be modified so that the one which are actually customers contain some type of indication that they are customers (e.g., the persons in the list who are customers of the bank may be tagged). Additionally, other information from the financial network (e.g., other second degree customers related to the customer, the amount of degrees of separation between customers, frequency of the transactions between customers, dates of the transactions between customers, amount of funds involved in the transactions between customers, whether the second customers are priority financial contacts of the first customer, etc.) may be used to update the customer profile. According to aspects of the disclosure, the customer profiles may be updated with supplemental information automatically at periodic times (e.g., once a week). Alternatively the customer profile could be updated each time a new data element is determined (e.g., a new financial contact is determined).

According to aspects of this disclosure, once a financial network 500 has been created, the bank may leverage the information from the financial network 500 for various purposes. For example, according to aspects of the disclosure, the bank may leverage the information from the financial network 500 to increase the likelihood of that customers will have goodwill towards the bank.

For example, as discussed above, according to such aspects of the disclosure, data from the financial network 500 may be transmitted to a customer's profile. For example, the data in the customer profile may include a listing of other customers of the bank with whom the customer has a financial relationship. For example, the customer profile information may designate the other customers of the bank with whom the customer has directly conducted a financial transaction. Additionally, according to aspects of the disclosure, the customer profile information may designate customers with whom the customer has not directly conducted a financial transaction, but may still potentially have a connection (e.g., customers who are within a second degree of the customer). Further, according to aspects of the disclosure, the customer profile information may have supplemental information including: frequency of the transactions between customers, dates of the transactions between customers, amount of funds involved in the transactions between customers, whether the second customers are priority financial contacts of the first customer, etc.

Further, it is noted that according to aspects of the disclosure, the bank may have instructions in a customer's profile to provide a particular level of service to the customer. The particular level of service may be based on several factors, including, but not limited to: the volume of business the customer does with the bank, the monetary value of the business the customer does with the bank, the length of time the customer has been with the bank, etc. The particular level of service provided to the customer may include: ensuring the customer does not have a wait time when they call in for telephone banking (e.g., they are directly transferred to an live person if they call from a telephone number in their profile), ensure the customer does not have to wait in line at a banking center (e.g., a client manager or other bank employee will greet them and provide individualized efficient service), waiving different bank fees for the customer, providing preferred interest rates for the customer, providing discounts on financial products or services, providing other incentives or promotional offers or gifts, etc.

According to aspects of the disclosure, the bank may leverage the financial network information to ensure that the persons within a customer's financial network 500 (e.g., the other customers of the bank with whom a customer has conducted financial transactions) are provided with at least the same level of service as the customer. According to other aspects of the disclosure, the bank may leverage the financial network information to ensure that persons of a certain level (e.g., persons that have been tagged with a particular designation within a customer's financial network, such as a priority financial contact of the customer) are provided with at least the same level of service as the customer.

For example, according to aspects of this disclosure, if high value customer calls the bank to conduct a transaction, their customer profile may contain instructions that the particular high value customer is to be treated with a particular level of service. Therefore, according to aspects of this disclosure, the customer profile may contain one or more phone numbers associated with the high value customer and, hence, when the high value customer calls via one of those phones, the phone system of the bank may recognize the phone number and perform actions consistent with the level of service to be provided to the customer. For example, the phone system may immediately transfer the call to live bank employee or representative to greet the high value customer and aid them in conducting business. Further, the customer profile may contain instructions on the level of service to the provided to the high value customer and other details that may be transmitted to the live bank employee's computer screen so that the live bank employee can have further information on providing the customer with the appropriate level of service. Of course, according to other aspects of the disclosure, this process of providing the live bank employee with the contain instructions on the level of service to the provided to the high value customer and other details does not have to be done automatically by the phone system. For example, the customer may call in and provide verification information in order for the live bank employee to retrieve the instructions on the level of service to the provided to the high value customer and other details on their computer. Similar process could be applied for online transactions, in person transactions, etc.

According to aspects of this disclosure, a customer of the bank who is in a first customer's financial network 500 will be provided at least the same level of service as the first customer.

For example, if a customer of the bank who is in a high value customer's financial network 500 contacts the bank (e.g., via phone, email, in-person, etc.), then that customer will be provided at least the same level of service as the high value customer. For example, in the above described example of a calling the bank to conduct a transaction, if a customer of the bank who is in a high value customer's financial network 500 calls the bank, the telephone number from which they are calling may be listed in the customer profile information, and hence, the member of the household would be routed so they would not have to wait on hold, just as if the customer himself had called. Additionally, a live bank employee would provide the same level of service of the caller as the live bank employee would have provided to the high value customer. For example, the computer system responsible for a customer profile may create a message that appears on the live bank employee's computer screen that this customer is a member of the high value customer's financial network and is to be treated with a particular level of service. Similarly, according to other aspects of the disclosure, this process of providing the live bank employee with the instructions on the level of service to the provided to the caller and other details does not have to be done automatically by the phone system. For example, as described above, the caller may call in and provide verification information in order for the live bank employee to retrieve the instructions on the level of service to the provided to the high value customer and other details on their computer. Similar process could be applied for online transactions, in person transactions, etc.

By leveraging the financial network information to provide the same level of service to the customers in the first customer's financial network (i.e., the persons with whom interacts the first customer interacts with financially), the bank increases the likelihood that those customers in the first customer's financial network will also have goodwill towards the bank. Hence, as a result of both the customer and the people with whom the first customer financially interacts with are being provided the same high level of service, the bank thereby increases the likelihood that the first customer is satisfied with their relationship with the bank and retains goodwill towards the bank.

According to other aspects of the disclosure, the financial network may also be expanded to include other people with whom the customer interacts. For example, it is noted that such a level of service could also be provided to members of the customer's household. For example, the customer profile may include a list of members of the customer's household. This information may have been provided by the customer or may have been ascertained through home address information, joint account information, etc. For example, as described above, according to aspects of this disclosure, a bank may have one or more computer systems that captures and stores such information about a customer and, therefore, the bank may leverage the information in order to ascertain and identify other persons (e.g., members of the household) with whom a customer interacts. Because these interactions between a customer and other persons (e.g., relatives who may not necessarily be customers) may also affect the goodwill towards the business, this embodiment of the disclosure would also increase the likelihood that the customer had goodwill towards the bank.

Further, aspects of this disclosure relate to a system of method that allows the customer to insert information regarding who is in the financial network. For example, the customer could provide members of the household, friends, colleagues, etc. by entering them into the system manually, contacting the bank to inform them of the member to be included in the financial network or by uploading data (e.g., an electronic address book) to the computer system.

Further, in addition to having a customer or bank employee actually inserting information regarding who is in the financial network, according to aspects of this disclosure, the bank may create or supplement a financial network by leveraging inferred connections between customer of the business based on factors such as the date and time of the customer transactions, the location of the transactions, the frequency of transactions, etc.

For example, even when there are no direct financial transactions between two customers of the bank, there may still be a connection between the customers (e.g., a social connection wherein the customers are friends, relatives, colleagues, etc.). According to aspects of the disclosure, the bank may infer such a social connection between the customers based on financial transactions by the customers. For example, if two people are both customers of the bank and each use a method of payment wherein funds are utilized from their respective accounts at the bank (e.g., the two customers both pay with a bank issued credit card, debit card, check, etc.), then the bank would have a record of the transactions and additional data regarding the transactions. Such data will include the date and time of the transactions, the location of the transactions, etc. As will be described in detail below, the bank can leverage such transaction data to infer social relationships between the customers. Further, the bank may create or supplement a financial network based on the inferred social connections between the different customers.

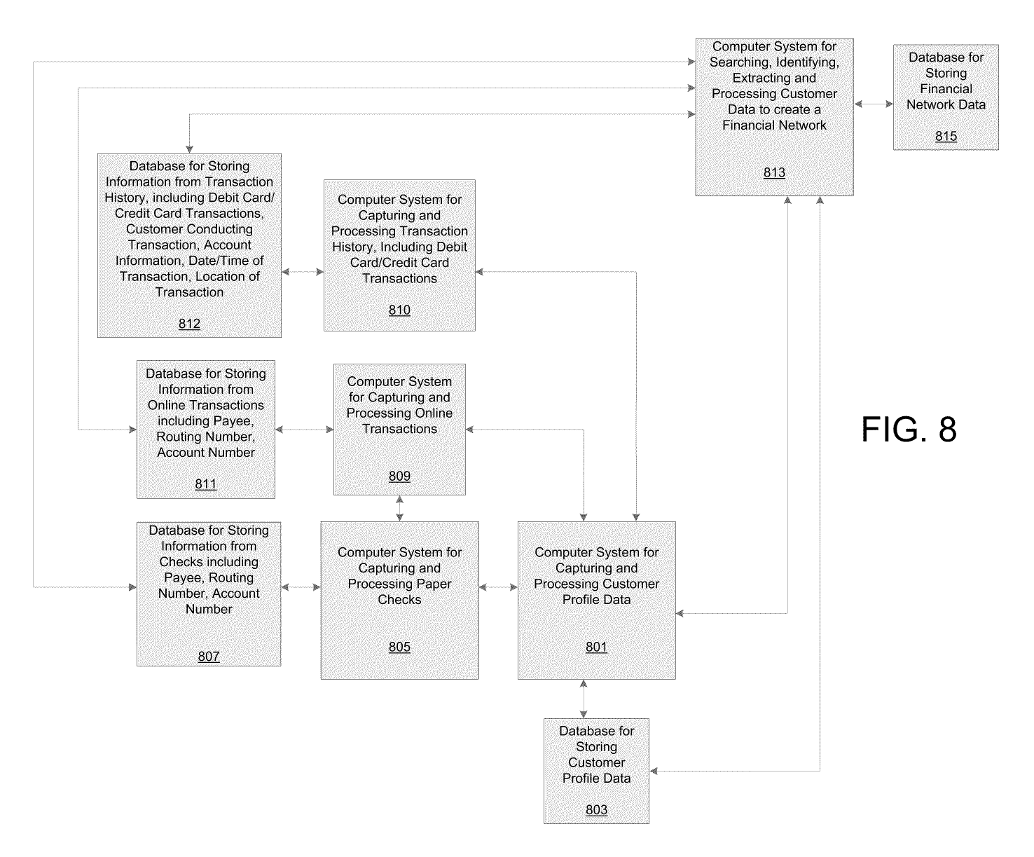

According to aspects of this disclosure, a bank may have one or more computer systems that captures and stores financial transaction history data for a customer and, therefore, the bank may leverage the data in order to ascertain and identify other persons (e.g., other customers of the business) with whom a customer interacts with socially. FIG. 8 illustrates a block diagram of a computing environment in which certain aspects of the present disclosure may be implemented. As seen in FIG. 8, a bank may have one or more computer systems 810 that are used for capturing and processing transaction history data. For example, if a customer makes a purchase using a bank issued debit card, credit card, check, etc., such a transaction and information related to the transaction (e.g., the date of the transaction, the time of the transaction, the location of the transaction (including the merchant to whom the payment was made, the address, zip code, city, state and county of the location of the transaction, etc.), the amount of funds involved in the transaction, the method of payment of the transaction (e.g., debit card, credit card, check, etc.) etc.) may be captured and processed by the computer system 810. Additionally, as seen in FIG. 8, the bank may have one or more databases 812 for storing such data. Further, as seen in FIG. 8, a bank may have additional computer systems for capturing, processing and storing data. These additional computer systems (e.g., 801, 803, 805, 807, 809, 811, 813 and 815) are similar to those described above with regard to FIG. 2 and, therefore, will not be elaborated on here in detail. However, it is noted that as seen in FIG. 8, data may be electronically transmitted and received between the computer systems.

According to aspects of the disclosure, a computer system (e.g., the computer system for searching, identifying, extracting and processing customer data to create a financial network 813) may examine and process customer financial transaction history data and infer social connections between customers based upon such data. For example, the computer system 813 may be configured to search customer transaction data from the database 812 to identify transactions by different customers of the bank that are in a common location (e.g., the same merchant) and within a predetermined time of each other (e.g., within five minutes). Further, the computer system 813 may be configured to compile a list of such transactions. Additionally, the computer system 813 may be configured to search the compiled list of transactions in order to identify if there are any additional transactions by those same customers (e.g., same group of customers) that are also in a common location (e.g., the same or a different merchant) and within a predetermined time of each other (e.g., within five minutes). The computer system 813 may be configured to compile a list of such customers who have at least a predetermined number of above described transactions within a predetermined time period. For example, computer system 813 may be configured to compile a list of such groups of customers who have at least five such transactions within one month. In this way, the computer system 813 can reduce the likelihood that the transactions are merely due to chance rather than a social connection between the customers. In other words, by setting a predetermined threshold for customer transactions which occur at a common location within a predetermined time of each other, the computer system 813 can ensure to a high probability that there is a social connection between the customers.

Hence, if the computer system 813 determines that the predetermined threshold has been obtained, the computer system 813 may be configured to establish a social connection between the two customers. Even though this social connection was based on inference, once established by the computer system 813, it would function in the same manner as described above with regard to a connection based a direct financial transaction between customers or a social or financial connection actually inputted by the customer or bank employee. For example, the inferred social connection would be stored in the database for storing financial network data 815 and leveraged in creating a financial network. Further, the social connection may be transmitted to and stored in the customer profile data store in database 803.

Aspects of the disclosure regarding leveraging transaction data to infer social connections between customers of the bank will be described with regard to an illustrative example. In the example, two friends who have not necessarily conducted any direct financial transactions with each other are shopping at a department store. The friends each purchase one or more items from the department store using a bank issued debit card. The friends are in line to check out together and, therefore, they purchase their respective items within 10 minutes of each other. Further, the two friends later have lunch at an eatery. The friends both use a bank issued debit card to pay their respective bills. The waiter conducting the payment swipes both cards within five minutes of each other. Thereafter, the two friends may continue travel to a different location (e.g., a merchant ten miles away from the department store) and each make purchases at that location using the bank issued debit card. Again, the friends are in line to check out together and purchase their respective items within 10 minutes of each other. One week later the same two friends may perform the same routine wherein they meet with each other and shop and eat together at common stores (which may be the same or different from the stores at which they shopped at the previous week). The computer system 810 captures and process transaction data (such as described above) for each of the transactions by each of the two friends. Further, the database 812 may store such transaction data.

In the illustrative example above, the computer system 813 may be configured to infer and establish a social connection between two bank customers if there are at least five transactions within a one month period by each customer wherein the transactions were made at the same merchant within 10 minutes of each other. Therefore, in the illustrative example above, the computer system 813 would infer and establish a social connection between the two friends because there were at least six such transactions within the one month time period. It is noted that this is merely a simple example to aid the reader in understanding the aspect of the disclosure. Factors affecting the establishment of a social connection between customers by the computer system 813, such as: the time period within which all the common transactions must be conducted, the time period within which a single transaction by a customer at a first merchant must be conducted relative to the single transaction by a second customer at the first merchant, the predetermined amount of transactions to establish the social connection, etc. may all be modified as desired.

Further, according to aspects of the disclosure, other factors from the transaction data may be used to establish a social connection between different customers. For example, if two customers go on a vacation together such a transaction may be strong evidence to infer a social connection. Therefore, the computer system 813 may be configured to examine any transactions wherein the customers are both making purchases within the above described parameters (e.g., same date, common merchant, within a predetermined time of each other, etc.), but the transactions are being conducted at a predetermined distance from the customer's respective addresses (e.g., 50 miles from the customer's respective addresses).

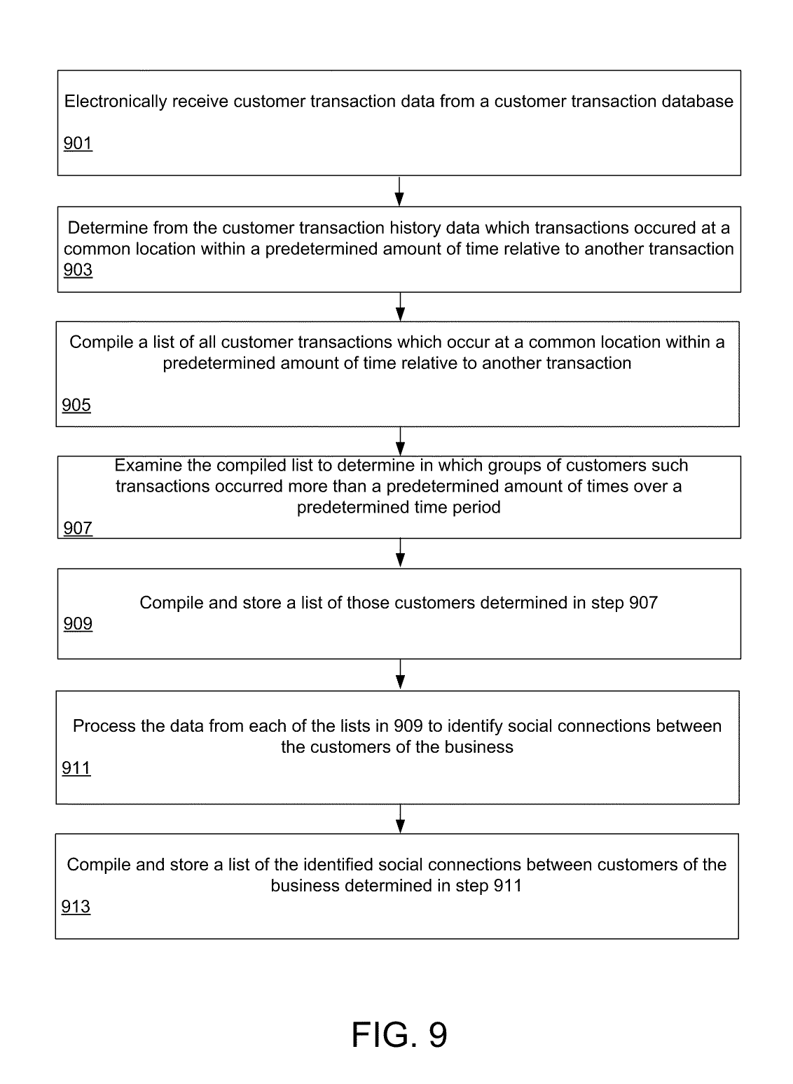

FIG. 9 is a flow chart which shows an illustrative method for creating a financial network according to aspects of the disclosure. Initially, it is noted that the bank may configure a computer system 813 to search for customer transaction history data for transactions which occur at a common location within a predetermined amount of time relative to another transaction. Therefore, the bank may use a computer system 813 to search a transaction history database 812 for transaction data. For example, as seen in step 901, the computer system 813 may electronically receive customer transaction data from the customer transaction database 812. In step 903, the computer system 813 may determine customer transactions which occur at a common location within a predetermined amount of time relative to another transaction. In step 905, the computer system 813 may compile a list of all customer transactions which occur at a common location within a predetermined amount of time relative to another transaction. In step 907, the computer system 813 may examine the compiled list to determine in which groups of customers such transactions occurred more than a predetermined amount of times over a predetermined time period. In step 909, the computer system 813 may compile and store a list of those customers determined in step 907. In step 911, the computer system 813 may process the data from the list created in step 909 to identify social connections between the customers of the business. In step 913, the computer system 813 may compile and store a list of the identified social connections between customers of the business determined in step 911.

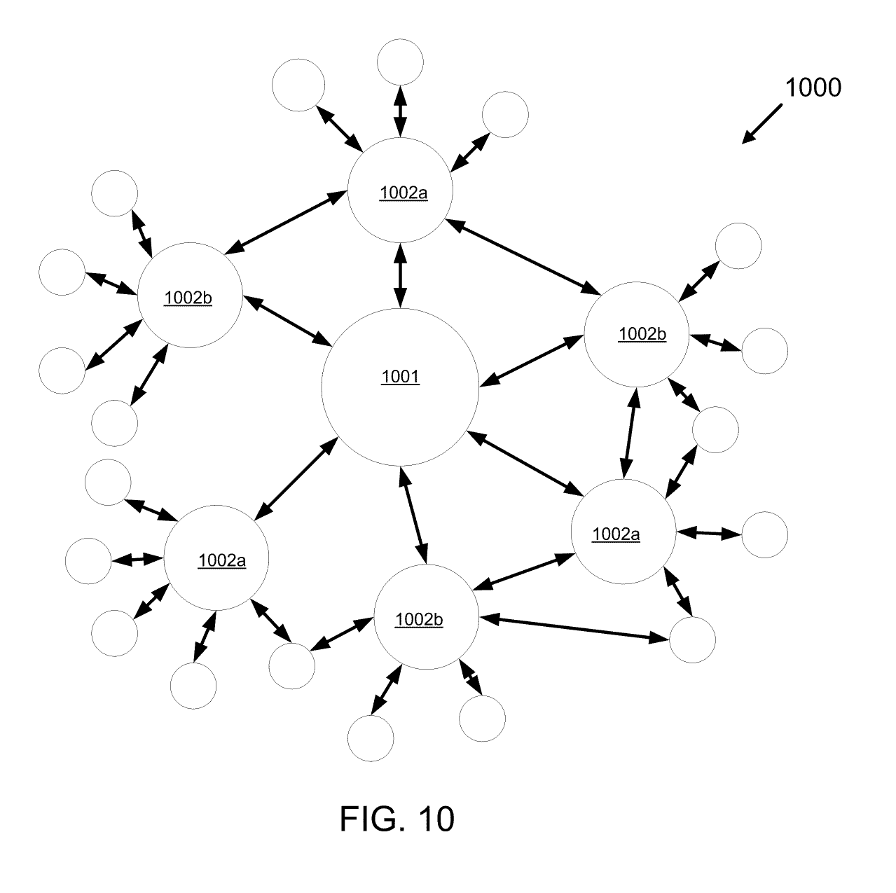

Hence, based on the above discussion it is understood that financial networks may be created or supplemented based on inferred social connections. For example, financial networks may be based: solely on financial connections (e.g., customers whom have conducted a direct financial transaction with one another), solely on social connections (either inferred or actually imputed by the customer or bank employee), or a combination of financial and social connections. For example, FIG. 10 demonstrates a financial network 1000 wherein a first customer 1001 has three second customers 1002a based on financial connections and three second customers 1002b based on social connections.

It is noted that the system for identifying relationships (e.g., financial relationships or social relationships) between customers of the business and leveraging such information to create and maintain goodwill towards the business may be an electronically based system, such as a web-based application. For example, the system may include a computer (such as described above), a network of computers, software that configures a computer to perform the below described features, etc. It is noted that according to aspects of the disclosure, the electronically based system for creating and maintaining financial networks and identifying relationships (e.g., financial relationships or social relationships) between customers of the business may include one or more algorithms to perform such tasks automatically. In other words, the electronically based business system may create and maintain the financial networks once the data has been electronically received.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A financial relationship and social relationship identifying computer comprising:
a processor; and
memory storing computer executable instructions that, when executed, cause the computer to perform a method for identifying financial relationships and social relationships between customers of a business, by:
determining one or more people with whom a first customer has conducted at least one financial transaction,
electronically receiving customer data providing identities of customers of the business;
determining which of the one or more people are also customers of the business by comparing the one or more people with the customer data; and
compiling a subset of the one or more people including customers of the business with whom the first customer has conducted at least one financial transaction;
determining one or more people with whom a first customer has a social relationship by:
electronically receiving customer financial transaction history data
determining customer transactions which occur at a common location within a predetermined amount of time relative to a second transaction;
determining in which groups of customers such transactions occurred more than a predetermined amount of times over a predetermined time period; and
inferring social relationship between the customers of the business when the transactions occurred more than a predetermined amount of times over a predetermined time period.

2. The computer according to claim 1, wherein identifying people with who a first customer has a financial relationship includes electronically receiving data from a customer profile which includes the list of those people with who the first customer has conducted at least one financial transaction.

3. The computer according to claim 2, wherein the list of people with who a customer has conducted at least one financial transaction includes data relating to the people with who a first customer has conducted at least one financial transaction which is obtained via a check drawn from or deposited into an account associated with the first customer.

4. The computer according to claim 3, wherein the data relating to people with who a first customer has conducted at least one financial transaction is data regarding the payee of the check.

5. The computer according to claim 3, wherein the data relating to people with who a first customer has conducted at least one financial transaction is data regarding the payor of the check.

6. The computer according to claim 2, wherein the list of people with who a customer has conducted at least one financial transaction includes data relating to the people with who a first customer has conducted at least one financial transaction which is obtained via an online transaction drawn from or deposited into an account associated with the first customer.

7. The computer according to claim 6, wherein the data relating to people with who a first customer has conducted at least one financial transaction is data regarding the payee of the online transaction.

8. The computer according to claim 6, wherein the data relating to people with who a first customer has conducted at least one financial transaction is data regarding the payor of the online transaction.

9. The computer according to claim 2, wherein identifying people with who a first customer has a financial relationship includes electronically receiving data which includes at least one of: the amount of transactions conducted between the people and the first customer, the amount of funds involved in the transactions conducted between the people and the first customer and time period since the most recent transaction conducted between the people and the first customer.

10. The computer according to claim 1, wherein the list of customers of the business with who a first customer has a financial relationship is transmitted to and stored in a customer profile associated with the first customer.

11. A computer assisted method for identifying financial relationships between customers of a business comprising:
electronically receiving data which contains a list of people with who a first customer of the business has conducted at least one financial transaction;
electronically receiving data regarding the identities of customers of the business;
using a financial relationship identifying computer to determine which of the people with who a first customer has conducted at least one financial transaction are also customers of the business by comparing the data relating to people with who a first customer has conducted at least one financial transaction with the data regarding the identities of customers of the business,
using a financial relationship identifying computer to compile a list of customers of the business with who a first customer has conducted at least one financial transaction.

12. The method according to claim 11, wherein the list of people with who a customer has conducted at least one financial transaction includes data relating to the people with who a first customer has conducted at least one financial transaction which is obtained via a check drawn from or deposited into an account associated with the first customer.

13. The method according to claim 12, wherein the data relating to people with who a first customer has conducted at least one financial transaction is data regarding the payee of the check.

14. The method according to claim 12, wherein the data relating to people with who a first customer has conducted at least one financial transaction is data regarding the payor of the check.

15. The method according to claim 11, wherein the list of people with who a customer has conducted at least one financial transaction includes data relating to the people with who a first customer has conducted at least one financial transaction which is obtained via an online transaction drawn from or deposited into an account associated with the first customer.

16. The method according to claim 15, wherein the data relating to people with who a first customer has conducted at least one financial transaction is data regarding the payee of the online transaction.

17. The method according to claim 15, wherein the data relating to people with who a first customer has conducted at least one financial transaction is data regarding the payor of the online transaction.

18. The method according to claim 11, wherein identifying people with who a first customer has a financial relationship includes electronically receiving data which includes at least one of: the amount of transactions conducted between the people and the first customer, the amount of funds involved in the transactions conducted between the people and the first customer and time period since the most recent transaction conducted between the people and the first customer.

19. A computer assisted method for providing a level of service to customers of a business comprising:
electronically receiving data which contains a list of people with who a first customer of the business has conducted at least one financial transaction;
electronically receiving data regarding the identities of customers of the business;
using a financial relationship identifying computer to determine which of the people with who a first customer has conducted at least one financial transaction are also customers of the business by comparing the data relating to people with who a first customer has conducted at least one financial transaction with the data regarding the identities of customers of the business,
using a financial relationship identifying computer to compile a list of customers of the business with who a first customer has conducted at least one financial transaction;
electronically receiving data regarding the level of service to be provided to a first customer;
providing the customers of the business with who a first customer has conducted at least one financial transaction with at least the same level of service that is to be provided to a first customer.

20. The method according to claim 19, further comprising electronically receiving data relating to people with whom a first customer has conducted at least one financial transaction, wherein the data includes at least one of: the amount of transactions conducted between the people and the first customer, the amount of funds involved in the transactions conducted between the people and the first customer and time period since the most recent transaction conducted between the people and the first customer.
